(19) United States
(12) Patent Application Publication
(10) Pub. No.: US 2008/0083908 A1
(43) Pub. Date: Apr. 10, 2008

(54) Bio-responsive and electrically conductive polymer compositions for tissue engineering and methods for production

(76) Inventors: Bor Z. Jang, Centerville, OH (US); Aruna Zhamu, Centerville, OH (US); Lulu Song, Centerville, OH (US)

Correspondence Address: Bor Z. Jang, 9436 Parkside Drive, Centerville, OH, 45458, US

(21) Appl. No.: 11/543,413

(22) Filed: Oct. 6, 2006

(51) Int. Cl. H01B 1/12

(52) U.S. Cl. 252/500

(57) ABSTRACT

A polymer composition that is both bio-responsive (bio-compatible, biodegradable, and/or bio-resorbable) and electrically conductive. The composition is composed of a bio-responsive host polymer and a desired amount of conductivity-rendering species that are introduced into the host polymer via high energy exposure, particularly ion bombardment or ion implantation. The host polymer is subjected to a high energy radiation with a dosage sufficient to produce an electrical conductivity no less than 10⁻⁴ S/cm, preferably no less than 10⁻² S/cm, and most preferably no less than 1 S/cm. Also disclosed is a method for producing a bio-responsive polymer with a controlled conductivity through ion implantation.

### FIELD OF THE INVENTION

This invention relates to polymers that are both bio-responsive (or bio-active) and electrically conductive. Hereinafter, the term bio-responsive or bio-active means bio-compatible, biodegradable, and/or bio-resorbable. This invention also relates to a method for producing these polymers, which are particularly useful for tissue regeneration procedures and other biomedical applications.

### BACKGROUND OF THE INVENTION

Future implantable or ingestable biomaterials will be programmable (can be tailor-made) and responsive to (or interactive with) surrounding tissues. For tissue engineering applications, materials that incorporate stimulatory signals, such as electrical pulses or charges, can be used to regulate cell attachment, growth, proliferation, and differentiation. The following references [Ref. 1-16] are related to this subject:
1. R. Goldman, S. Pollack, “Conductivity of a Chronic Wound Model,” Bio-electromagnetics, 17 (1996) 450.
2. C. E. Schmidt, V. R. Shastri, J. P. Vacanti, R. Langer, “Stimulation of Neurite Outgrowth Using an Electrically Conducting Polymer,” Proc. Natl. Acad. Sci. USA, 94 (1997) 8948.
3. A. Kotwal and C. E. Schmidt, “Electrical Stimulation Alters Protein Adsorption and Nerve Cell Interactions with Electrically Conducting Biomaterials,” Biomaterials, 22 (2001) 1055.
4. X. Cui, V. A. Lee, Y. Raphael, J. A. Wiler, J. F. Hetke, D. J. Anderson, D. C. Martin, “Surface Modification of Neural Recording Electrodes with Conducting Polymer/Biomolecule Blends,” J. Biomed. Mater. Res. 56 (2001) 261.
5. J. H. Collier, J. P. Camp, T. W. Hudson, C. E. Schmidt, “Synthesis and Characterization of Polypyrrole-Hyaluronic Acid Composite Biomaterials for Tissue Engineering Applications,” J. Biomed. Mater. Res. 50 (2000) 574.
6. V. R. Shastri, C. E. Schmidt, R. S. Langer and J. P. Vacanti, “Neuronal Stimulation Using Electrically Conducting Polymers,” U.S. Pat. No. 6,095,148 (Aug. 1, 2000).
7. V. R. Shastri, N. Rahman, I. Martin, R. S. Langer, Jr., “Electroactive Materials for Stimulation of Biological Activity of Bone Marrow Stromal Cells,” U.S. Pat. No. 6,190,893 (Feb. 20, 2001).
8. V. R. Shastri, I. Martin, R. S. Langer, N. Rahman, “Electroactive Materials for Stimulation of Biological Activity of Stem Cells,” U.S. Pat. No. 6,569,654 (May 27, 2003).
9. J. Y. Wong, D. E. Ingber, and R. S. Langer, “Method for Altering the Differentiation of Anchorage Dependent Cells on an Electrically Conducting Polymer,” U.S. Pat. No. 5,843,741 (Dec. 1, 1998).
10. R. Langer and J. Vacanti, “Tissue Engineering,” Science, 260 (1993) 920.
11. T. J. Rivers, T. W. Hudson, and C. E. Schmidt, “Synthesis of a Novel, Biodegradable Electrically Conducting Polymer for Biomedical Applications,” Adv. Functional Materials, 12 (2002) 33-37.
12. C. E. Schmidt and T. J. Rivers, “Biodegradable, Electrically Conducting Polymer for Tissue Engineering Applications,” U.S. Pat. No. 6,696,575 (Feb. 24, 2004).
13. B. D. Pless, “Neurostimulator Involving Stimulation Strategies and Process for Using it,” U.S. Pat. No. 6,944,501 (Sep. 13, 2005).
14. T. Kurata, “Biological Electrode,” U.S. Pat. No. 6,650,922 (Nov. 18, 2003).
15. A. Donat-Bouillud, L. Mazerolle, P. Gagnon, L. Goldenberg, M. C. Petty, M. Leclerc, “Synthesis and Characterization of Polyesters Derived from Oligothiophenes,” Chem. Mater., 9 (1997) 2815.

In particular, as indicated in these references and those references cited in [Refs. 1-15], researchers have demonstrated that electrical fields can stimulate the healing of bone, cartilage, skin and connective tissue, cranial and spinal nerves, and peripheral nerves. Specifically, electro-active materials can be used to locally deliver an electrical stimulus at the site of damage and also provide a physical template for cell growth and tissue repair. For instance, polymer electrets were used to provide permanent charges and piezoelectric materials were applied to generate transient surface charges. Studies using these materials have demonstrated enhancement of nerve and bone cell growth in vitro and in vivo. Another class of electroactive polymers of interest is the electrically conducting polymer. Examples include polypyrrole used for in vitro enhancement of nerve cell axonal extension with application of either constant current or constant voltage [Refs. 2, 3, 11, 12]. Polypyrrole was also used as a substrate to increase electronic interfacing between neurons and micro-machined micro-electrodes for potential applications in neural probes and prosthetic devices [Ref. 4].

In comparison with polymer electrets and piezoelectric materials, electrically conducting polymers offer several advantages for biomedical applications. First, conducting polymers allow external control over the level and duration of stimulation. Second, in contrast to piezoelectric materials, conducting polymers do not require extensive processing (e.g., stretching and poling) to render them electroactive. Third, conducting polymers can be modified with negatively charged dopant ions, which can be tailored to specific applications. For example, polypyrrole was doped with biological anions such as hyaluronan, which stimulates angiogenesis as it degrades [Refs. 5, 6] and adhesive peptides, which enhance material/cell interactions [Ref. 4]. A study was conducted on altering the differentiation of anchorage dependent cells on an electrically conducting polymer [Ref. 9]. Polypyrrole and polythiophene, however, are not biodegradable, and materials that remain in the body long-term may induce chronic inflammation and require surgical removal. The use of biodegradable materials in clinical applications has become increasingly variable and attractive [Ref. 10].

Rivers and Schmidt [Ref. 11, 12] have recently synthesized a polymer that possesses the unique properties of being both electrically conducting and biodegradable. Their synthesis strategy consisted of tethering conductive pyrrole/thiophene oligomers together with biodegradable ester linkages using an aliphatic linker. Oligomers of these conducting polymers were selected because Rivers and Schmidt noticed that (a) oligomers of thiophene possess electrical properties [Ref. 15] and (b) defects in the p-conjugation of polypyrrole are present in frequencies of one defect per three pyrrole rings. This latter observation prompted them to speculate that intact polypyrrole might not be essential for conductivity and that oligomers might be sufficient Ester linkages were chosen for degradation sites because they possibly could be cleaved by enzymes, such as cholesterol esterase, which might be secreted by cells during normal wound repair processes. It was further speculated that, after polymer degradation, the remaining oligomers could be readily consumed by macrophages during the normal wound healing response, reducing chances of long-term, adverse responses. These speculations have yet to be verified experimentally. Although ester linkages themselves could be biodegradable, the pyrrole or thiophene oligomers are not biodegradable or bio-resorbable.

The development of pyrrole/thiophene-based conducting and biodegradable polymers by Rivers and Schmidt [Ref. 11, 12] represents a major advancement in the field of bio-materials for tissue engineering. However, for any electroactive material intended for tissue engineering applications, an over-ridding concern is bio-compatibility and bio-resorbability (or absorbability after degradation), which has yet to be adequately addressed by conducting polymer researchers.

The primary goal of the present invention is to provide a new class of polymer compositions that is both bio-responsive (bio-compatible, biodegradable, and/or bio-resorbable) and electrically conductive, which is intended for tissue engineering, implantable materials and devices, and other biomedical applications. Instead of following the conventional strategy of selecting a conducting polymer and then modifying it to hopefully become biodegradable, we follow an alternative approach that entails selecting a bio-responsive host polymer and then imparting electrical conductivity to this host polymer, primarily via ion bombardment (e.g., ion implantation). Our research tasks have included ion-irradiating selected bio-responsive polymers to a desired range of dosages. Both surface and bulk electrical conductivities of the ion-implanted polymers were measured. Bio-activities (bio-compatibility, biodegradability, and bio-resorbability) of selected ion-irradiated and un-irradiated polymers were evaluated through in vitro cell interaction studies. We have found that such an alternative strategy normally results in the formation of a conducting polymer that is controllably bio-responsive. We have further surprisingly observed that normally the bio activities were not compromised by ion implantation. On the contrary, ion bombardment can be used to alter (usually increase) the biodegradation rate of a polymer in a controlled manner if so desired. Hence, ion bombardment provides a versatile approach to enhancing the electrical conductivity of a bio-responsive polymer and, if deemed beneficial, altering other properties of the polymer in a well-controlled fashion.

It may be noted that ion irradiation has been used to improve surface compatibility of a polymer with cells [e.g., Refs. 16-18 below]. Additionally, ion implantation was used to enhance electrical conductivity to a polymer mostly for the purposes of fabricating desired electronic devices [19-23]. However, ion implantation was not utilized in these earlier research efforts to impart electrical conductivity to a bio-responsive polymer for applications such as (1) serving to transmit electrical signals to stimulate tissue regeneration in a scaffold composed of an electrically conductive and bio-responsive polymer and (2) bio-electronic applications in which a transient electronic-tissue interface is desired.
16. J. S. Lee, M. Kaibara, M. Iwaki, H. Sasabe, Y. Suzuki, and M. Kusakabe, “Selective Adhesion and Proliferation of Cells on Ion-Implanted Polymer Domains,” Biomaterials, 14 (12) (October 1993) 958-960.
17. L. Bacakova, V. Mares, M. G. Bottone, C. Pellicciari, V. Lisa, and V. Svorcik, “Fluorine Ion-Implanted Polystyrene Improves Growth and Viability of Vascular Smooth Muscle Cells in Culture,” J. Biomed. Mater. Res., 49 (3) (March 2000) 369-379.
18. N. Huang, P. Yang, Y. X. Leng, J. Wang, H. Sun, J. Y. Chen, and G. J. Wan, “Surface Modification of Biomaterials by Plasma Immersion Ion Implantation,” Surface & Coatings Technology, 186 (2004) 218-226.
19. H. Mazurek, D. R. Day, E. W. Maby, and J. S. Abel, “Conductive Polymers Formed by Ion Implantation,” U.S. Pat. No. 4,491,605 (Jan. 1, 1985).
20. S. R. Forrest, M. L. Kaplan, P. H. Schmidt, and T. Venkatesan, “Process of Enhancing Conductivity of Material,” U.S. Pat. No. 4,511,445 (Apr. 16, 1985).
21. K. F. Schoh, J. Bartko, M. H. Hanes, and F. H. Ruddy, “Production of Highly Conductive Polymers for Electronic Circuits,” U.S. Pat. No. 5,250,388 (Oct. 5, 1993).
22. R. E. Giedd, Y. Wang, M. G. Moss, J. Kaufmann, and T. L. Brewer, “Homogeneously Conductive Polymer Films as Strain Gauges,” U.S. Pat. No. 5,505,093 (Apr. 9, 1996).
23. R. E. Giedd, M. G. Moss, J. Kaufmann, and T. L. Brewer, “Method for Making Airbridge from Ion-Implanted Conductive Polymers,” U.S. Pat. No. 5,753,523 (May 19, 1998).
24. D. V. Sviridov, “Chemical Aspects of Implantation of High-Energy Ions into Polymeric Materials,” Russ. Chem. Rev., 71(4) (2002) 315-327.
25. A. L. Evelyn, D. 11a, R. L. Zimmermann, K. Bhat, D. B. Poker, D. K. Hensley, “Resolving the Electronic and Nuclear Effects of MeV Ions in Polymers,” Nucl. Instr. and Meth. B, 127/128 (1997) 694.
26. J. Davenas, X. L. Xu, G. Boiteux, and D. Sage, Nucl. Instrum. and Meth., B39 (1989) 754.
27. J. Robertson, “Amorphous Carbon,” Advances in Phys., 35 (1986) 317.

The clinical implications associated with research in tissue engineering are enormous. For example, the costs associated with tissue loss and organ failure have been estimated to be over $400 billion dollars each year. The proposed approach is suitable for tissue engineering of a wide range of cell structures, including bone, cartilage, tendon, ligament, nerve, blood vessel, skin, bladder, heart, liver, kidney, and lung. For bone and cartilage repair and replacement applications alone, the potential utility value of the present invention is huge. This is based on the notion that over 1 million surgical operations involving bone repair are performed annually in the USA alone.

### SUMMARY OF THE INVENTION

Considerable R&D effort has been made in the design and fabrication of a new class of polymers that is both bio-responsive and electrically conductive for tissue engineering applications. The results have demonstrated that: (1) Controlled electrical conductivity can be imparted to bio-responsive polymers via ion irradiation (ion bombardment or implantation); and (2) Desired bio-activities (bio-compatibility, biodegradability, and/or bio-resorbability) was not adversely affected by ion irradiation. These results serve to establish a new platform technology for the design and manufacturing of a wide range of biologically and electrically active polymers for biomedical applications.

Hence, a preferred embodiment of the present invention is a polymer composition that is both bio-responsive and electrically conductive. The composition is composed of a bio-responsive host polymer and a desired amount of conductivity-rendering species that are introduced into the host polymer via high energy exposure (e.g., ion bombardment). The host polymer is subjected to a high energy radiation with a dosage sufficient to produce an electrical conductivity no less than 10⁻⁴ S/cm, preferably no less than 10⁻² S/cm, and most preferably no less than 1 S/cm.

Another preferred embodiment of the present invention is a method for producing a bio-responsive polymer with a controllable conductivity without adversely affecting the bio-activities of the original polymer. The resulting material has great potential for a broad range of applications such as (1) tissue engineering applications as a temporary scaffold for cell attachment and as a source of electrical signals to stimulate tissue regeneration and (2) bio-electronic applications in which a transient electronic-tissue interface is desired. In addition, bio-degradable polymers that are electrically conductive may be used as a bio-electrode material which, when disposed of, will be rapidly degraded without having a negative impact on the environment.

### BRIEF DESCRIPTION OF THE DRAWINGS

FIG. 1 A bio-active polymer subjected to ion bombardment, forming an electrically conductive surface layer. The thickness of this ion-implanted or ion-penetrated layer scales with the ion dosage.

### PREFERRED EMBODIMENTS OF THE PRESENT INVENTION

Rather than following the prior-art approach of selecting a conducting polymer and then modifying it to hopefully become biodegradable, an alternative strategy is to select a bio-responsive polymer and then impart electrical conductivity to it. We have achieved this purpose and, surprisingly, have done so without compromising the bio-activity of the original polymer.

There are six ways to make a polymer electrically conducting: (1) via pyrolysis (e.g., carbonization of phenolic and phthalonitrile resins), (2) adding conductive fillers (e.g., adding carbon black, metal flakes, or conductive fibers to a polymer matrix), (3) introducing intrinsically conductive, conjugate chains (e.g., polyaniline, polypyrrole, and polyacetylene), (4) producing organometallic polymers by complexing transition metals with conjugated bridging ligands (e.g., poly(metal-tetrathio-oxalates)), (5) doping, and (6) ion beam modifications. Although ion beam modification approaches, such as ion implantation of polymers, have been proposed for more than two decades, their application to conductivity enhancement of bio-responsive polymers for biomedical applications (particularly for tissue engineering) has been hitherto largely overlooked.

Imparting electrical conductivity to polymers via ion beam modifications has a major advantage in that significant modifications to the surface structure and properties of a polymer can be achieved without adversely affecting its bulk structure and properties. Specifically, ion implantation does not alter any of the desired bulk properties such as density, flexibility, mechanical strength, and chemical properties. Our research results have now demonstrated that ion irradiation does not adversely affect the bio-activity. On the contrary, the bio-activity can be positively impacted in a controlled manner. The surface of an ion-implanted polymer becomes more electrically conductive, mechanically harder, and more wear and scratch resistance. Further, ion implantation has been found to be effective in promoting selective cell adhesion, growth and proliferation on polymer surfaces. If so desired, the entire bulk of a polymer (a thin or thick film) can be ion-irradiated to become a semiconducting (n-type or p-type) or conducting polymer if an ion beam of sufficiently high energy and dosage is invoked.

Our research efforts began with the selection of bio-responsive polymers for ion irradiation. Suitable bio-responsive polymers for tissue engineering applications include natural polymers such as collagen, albumin, hyaluronic acid, fibrinogen-fibrin, and chitosan, as well as synthetic polymers such as synthetic proteins, aliphatic carbonate-based polymers (e.g., tyrosine-derived polycarbonates), dioxanone- and dioxepanone-based polymers, polyphosphazenes, poly(anhidrides), poly(ortho esters), poly(amino acids), poly(propylene fumarate), and alginate hydrogels.

Synthetic biodegradable polymers are currently being used or investigated for use in wound closure (sutures, staples); orthopedic fixation devices (pins, rods, screws, tacks, ligaments); dental applications (guided tissue regeneration); cardiovascular applications (stents, grafts); and intestinal applications (anastomosis rings). Most of the commercially available biodegradable devices are polyesters composed of homopolymers or copolymers of glycolide and lactide. However, broadly speaking, biodegradable polyesters include poly(glycolic acid), poly(lactic acid), poly(glycolic-co-lactic acid), poly(dioxanone), poly(caprolactone), poly(3-hydroxybutyrate), poly(hydroxyvalerate), poly(valerolactone), poly(tartronic acid), and Poly(β-malonic acid). Bio-responsive polymers can also be chosen from copolymers of trimethylene carbonate and ε-caprolactone.

In most of the samples studied, ion implantation was carried out at 30-150 keV and up to 10 mA, with a dosage range of 1×10¹³-5×10¹⁷ ions/cm². N₂⁺, Ne⁺, Na⁺ and Ca⁺ ion implantation was used to modify bio-responsive polymers in both micro-porous or non-porous forms with a view to assessing the effect of ion implantation on the chemical and physical structure of these materials as well as the effect of porosity on the response to ion implantation. This study was important since scaffolds for tissue engineering are normally porous. In another set of samples, Ag, Cu, and Si ions were introduced into polymers. Both aromatic and aliphatic bio-polymers were ion-implanted with the purpose of providing a better understanding of how high-energy ion-induced chemical changes, such as bond breaking, chain scission and reformation, cross-linking, oxidation and hydrogen stripping, are correlated with the molecular chain structures and how condensed aromatic ring structures or carbon clusters are formed. These aromatic structures or carbon clusters are speculated to be responsible for the enhanced electrical conductivity of many ion-implanted polymers.

Implantation of ions into polymers could lead to radiation damages, which modify the electrical properties of the surface of materials. These modifications result from the changes in chemical bonding and chemical structure that occur when the incident ions cut the polymer chains, break covalent bonds, promote cross-linking, and liberate certain volatile species [Refs. 24, 25]. The nature of these changes depends on the linear energy transformation, ion energy, incident ion mass, and irradiation dose. According to current knowledge, high energy ions of the beam scatter on the target atoms, dissipating energy that causes some changes in polymer chain structure. The dominant mechanism for energy transfer from ions to polymer is thought to be the inelastic collision, inducing the formation of free radicals and subsequent chemical reactions in the polymer. Polymer chain rupture, cross-links, unsaturated bond formation, and gas liberation take place as a result of ion irradiation at low dose range [Ref. 26]. Consequently, various structures including regions of condensed aromatic structures are formed in the ion damage path. The resulting carbon clusters or domains are thought to act as hopping centers for charge transport. When the irradiation dosage increases, the carbonization degree of polymer is increased [Ref. 27]. Although the detailed knowledge of chemical processes in ion-implanted polymers is still incomplete, it is now believed that the resulting free radicals, condensed aromatic rings, and carbon clusters are responsible for the much enhanced electrical conductivity in ion-bombarded polymers. In addition to these conductivity-rendering species, the metal ions or atoms implanted into a polymer during metal ion implantation could provide additional charge transport paths.

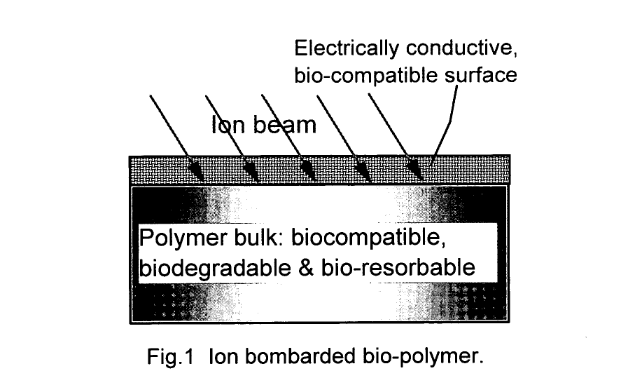

As schematically shown in FIG. 1, ion bombardment can be conducted in such a manner that ion implantation and radiation-induced chemical effects are limited to a surface layer of a polymer. The size of this ion-influenced zone scales with the ion dosage. If exposed to a sufficient level of ions, the entire volume of a polymer sample can be affected. This implies that either surface properties alone or both surface and bulk properties of a polymer can be altered in a controlled manner to achieve a desired set of properties.

In the present study, X-ray photoelectron spectroscopy (XPS) was used for the characterization of chemical structural changes in the surface of ion-implanted samples. Surface bonding structure of these samples was investigated with ESCA (Electron Spectroscopy for Chemical Analysis), while scanning electron microscopy (SEM) was used for the characterization of physical structural changes. Polymer films were spin-coated onto a glass slide and contact angles were obtained using a goniometer. UV-vis spectra were recorded on a spectrophotometer using a 1 cm path cell to identify the biodegradation products. Gel permeation chromatography (GPC) measurements were conducted to assess molecular weight and polydispersity index of a polymer before and after ion implantation and, in some cases, to monitor the molecular weight changes as a function of in vitro degradation time. Polymer films for conductivity measurements were prepared by spin casting. Measurements were made using the four-point probe technique. The voltage was measured using a multimeter with a constant current source.

In-Vitro Biodegradation Studies: Using poly(caprolactone) as an example, ion-irradiated and un-irradiated polymer films (3.0 cm×2 cm×2 mm) were incubated in 1.5 mL of phosphate-buffered saline (PBS, pH 7.0) at 37° C. The PBS was replaced after 24 h with 1.5 mL of fresh PBS and with cholesterol esterase (100 units in 1.5 mL of PBS). Samples were rotated at 37° C. for 2 weeks. The supernatant was used for UV-vis analysis and the polymer was used in GPC analysis. We have confirmed that both ion-irradiated and un-irradiated samples could be degraded under representative biological conditions. For instance, after two weeks, degradation products were found in the supernatant of solutions containing poly(caprolactone), PBS and esterase. The amounts of biodegradation products from the ion-irradiated and the corresponding un-irradiated polymers were approximately the same, as determined by UV-VIS analyses. GPC analysis data have indicated the same decay rates of polymer molecular weights over time between the surface-irradiated (e.g., 1×10¹⁵ ions/cm²) and un-irradiated polymer. With a higher ion dosage (hence, deeper penetration into bulk of the polymer), the biodegradation rate is expected to increase significantly.

In-Vitro Cell Compatibility Studies: It is essential that the polymers be non-toxic to biological systems and able to support cell growth if they are to be used as an implantable material for tissue engineering or other purposes. The polymers that we have chosen (the aforementioned natural and synthetical polymers) are all known to be bio-compatible and most of them are bio-resorbable. However, we wanted to know if their ion-irradiated counterparts were equally bio-compatible. Polymer films from poly(lactic-co-glycolic acid) and chitosan were prepared in the same manner as for conductivity studies. Films were vacuum dried and soaked in deionized distilled water (DDW) overnight. Human neuroblastoma cells (SK-N-SH, American Type Culture Collection) were seeded on the polymers in Eagle's minimum essential medium (EMEM) with 2 mM L-glutamine, Earles's balanced salt solution, 1.5 g/L sodium bicarbonate, 0.1 mM non-essential amino acids, 1.0 mM sodium pyruvate, and 10% fetal bovine serum (FBS). These wells were placed in sterile petri dishes and cultured at 37° C., 5% CO₂. Cells were found to adhere to ion-irradiated and un-irradiated versions of both poly(lactic-co-glycolic acid) and chitosan and readily express their nerve-like phenotype by extending neurites after one day. After 7 days, significant call proliferation was observed. These results demonstrate that in addition to being non-toxic to cells in culture, the polymers can also support cell attachment and proliferation. It may be noted that nerve cells were used because they depend strongly on favorable cell-surface interactions in order to express their neural phenotype. Therefore, nerve cultures provide a good measure of bio-compatibility.

Additional examples are given below:

### EXAMPLE 1

The adhesion and proliferation of endothelial cells was found to be drastically improved when the cells were cultivated on an ion-implanted polymer surface. When the surface of polycaprolactone scaffold (macro-porous structure), where endothelial cells were not capable of proliferating, was modified by Ne⁺ or Na⁺ ion implantation with a fluence of 1×10¹⁵ ions/cm² at an energy of 150 keV, cell adhesion and proliferation occurred selectively on the ion-implanted region irrespective of the ion species. The conductivity of the resulting polymer was between 10⁻⁴ S/cm and 10⁻² S/cm. The cells did not proliferate at ion fluences below 1×10¹⁴ ions/cm² (resulting in a conductivity lower than 10⁻⁶ S/cm). Most cells migrated into the ion-implanted domain within 1-2 h, but some of the cells attached outside of the region and then slowly migrated into the region. Ion implantation of chitosan, on which cells are capable of proliferating, further promoted cell spreading and proliferation, and increased resistance to detachment when the cells were exposed to trypsin.

### EXAMPLE 2

poly(ortho esters) and poly(3-hydroxybutyrate) (PHB) were modified by Ag, Cu, and Si ion implantation with a dose ranging from 1×10¹⁶ to 2×10¹⁷ ions/cm² using a metal vapor vacuum arc (MEVVA) source. The electrical properties of these two polymers were improved by metal ion implantation. The conductivity of both implanted polymers were increased with an increase in ion dosage, with a conductivity of up to 10⁻⁴-10⁻¹ S/cm being readily achievable. In order to understand the mechanism of electrical conduction, the structures of implanted layers were observed in detail by X-ray diffraction (XRD) and transmission electron microscopy (TEM). We found that nano-scaled carbon particles were dispersed in all implanted polymers. For Ag and Cu implanted polymers, nano metallic particles were observed in metallic ion implanted layers with dose range from 1×10¹⁶ to 1×10¹⁷ ions/cm². A nano-scaled metal network structure, serving as a continuous electron transport path, was formed in implanted layer when a dose of 2×10¹⁷ ions/cm² was reached. Anomalous fractal growths were also observed. These structural features, comprising carbon or metal atoms, appear to be responsible for conductivity improvements.

### EXAMPLE 3

Poly(3-hydroxybutyrate) (PHB) is the simplest of polyhydroxyalkanoate (PHA) polyesters that are biodegradable and biocompatible. However, they are highly crystalline, extremely brittle, and relatively hydrophobic. Consequently, PHA homo-polymers, including PHB, have been found to have degradation time in vivo on the order of years. They are known to be too hydrolytically stable to be useful in short-term applications when resorption of the biodegradable polymer within less than one year is desirable. On the positive side, however, is the notion that PHB has been found to have low toxicity, in part due to the fact that it degrades in vivo to d-3-hydroxybutyric acid, a normal constituent of human blood. Hence, it would be advantageous and highly desirable to develop an ability to accelerate the degradation process of PHB and other related PHA polymers without sacrificing other desirable properties. We were pleasantly surprised to observe that, in addition to improved electrical conductivity, the hydrolytic degradation rate of PHB was dramatically enhanced by exposing PHB to ion bombardment.

Three PHB samples were studied: PHB-S-A (un-irradiated), PHB-S-B (10¹⁶ Si ions/cm²), and PHB-S-C (10¹⁷ Si ions/cm²). Ion-irradiated and un-irradiated polymer films (3.0 cm×2 cm×2 mm) were incubated in 1.5 mL of phosphate-buffered saline (PBS, pH 7.0) at 37° C. The PBS was replaced after 72 h with 1.5 mL of fresh PBS and with cholesterol esterase (100 units in 1.5 mL of PBS). Samples were treated at 37° C. for up to 6 months. The supernatant was used intermittently for UV-vis analysis and the polymer was used in GPC analysis at selected time intervals. The degradation process was also monitored gravimetrically by weight loss. No significant weight loss was observed with PHB-S-A after 6 months. In contrast, a significant weight loss was observed with PHB-S-B (6%) and PHB-S-C (11%), confirming that ion-irradiation could accelerate biodegradation of PHB under representative biological conditions.

For tissue engineering applications: Ion-irradiated bio-polymers, being electrically conducting, can be used to locally deliver an electrical stimulus at the site of tissue damage. The ion-treated polymer surface, being more bio-compatible, can promote selective cell adhesion, growth and proliferation. The bulk of the polymer, being biodegradable and bio-resorbable, will be gradually assimilated with or absorbed by the living body without inducing chronic inflammation or requiring surgical removal.

For other biomedical applications: The developed approach provides a versatile platform technology for the development of electro-active bio-materials for use in implantable or ingestable devices such as in-vivo bio-sensors and RFID-based telemetry pills. Future implantable or ingestable devices will consist of a range of passive and active micro-electronic or nano-electronic components. Passive components include the conductor (e.g., RF antenna), insulator, dielectric, capacitor, and inductor while active components include the transistor, junction devices (e.g., light-emitting diodes), and power sources (e.g., battery). In addition, bio-degradable polymers that are electrically conductive may be used as a bio-electrode material which, when disposed of, will be rapidly degraded without having a negative impact on the environment. Electronically active and bio-responsive polymers will have great utility value in these applications. Hence, another embodiment of the present invention is a bio-electronic device, such as the aforementioned, that comprises a bio-responsive and electrically conductive polymer wherein the conductivity is enhanced via ion bombardment.

1. An electrically conductive and bio-responsive polymer composition, comprising:
(a) a host polymer that is bio-compatible, biodegradable, and/or bio-resorbable; and
(b) a desired amount of conductivity-rendering species that are introduced into the host polymer by subjecting said host polymer to high energy radiation with a dosage sufficient to produce an electrical conductivity no less than 10⁻⁴ S/cm.

2. The polymer composition of claim 1 wherein said electrical conductivity is no less than 10⁻² S/cm.

3. The polymer composition of claim 1 wherein said host polymer comprises a naturally occurring polymer selected from the group consisting of collagen, albumin, hyaluronic acid, fibrinogen-fibrin, chitosan, their chemical derivatives, and combinations thereof.

4. The polymer composition of claim 1 wherein said host polymer comprises a polymer selected from the group consisting of tyrosine-derived polycarbonates, dioxanone- and dioxepanone-based polymers, polyphosphazenes, poly(anhidrides), poly(ortho esters), poly(amino acids), poly(propylene fumarate), alginate hydrogels, poly(glycolic acid), poly(lactic acid), poly(glycolic-co-lactic acid), poly(dioxanone), poly(caprolactone), poly(ε-hydroxybutyrate), poly(ε-hydroxyvalerate), poly(valerolactone), poly(tartronic acid), poly(β-malonic acid), and combinations thereof.

5. The polymer composition of claim 1 wherein said high energy radiation comprises an ion beam.

6. The polymer composition of claim 1 wherein said high energy radiation comprises an ion beam with a kinetic energy of at least 50 KeV and said dosage comprises a particle beam having a fluence from about 10¹³ to about 5×10¹⁷ particles/cm².

7. The polymer composition of claim 1 wherein said high energy radiation comprises an ion beam with a kinetic energy of at least 100 KeV and said dosage comprises a particle beam having a fluence from about 10¹⁴ to about 10¹⁶ particles/cm².

8. The polymer composition of claim 1 wherein said conductivity-rendering species comprise metallic elements, metallic ions, condensed aromatic rings, and/or carbon.

9. The polymer composition of claim 1 wherein said conductivity-rendering species comprise metallic elements, metallic ions, condensed aromatic rings, and/or carbon that form an electron-conducting nanometer-scaled domain or network structure.

10. The polymer composition of claim 1 wherein said host polymer is in the form of a polymer film, fiber, porous membrane, porous scaffold, matrix, or a combination thereof.

11. The polymer composition of claim 1 wherein a biodegradation rate or bio-compatibility of said host polymer is not reduced by said high energy radiation.

12. An electrically conductive and bio-responsive polymer composition, comprising a polymer that is bio-compatible, biodegradable, and/or bio-resorbable and at least a portion of said polymer is subjected to ion bombardment or ion implantation with an ion dosage sufficient to produce an electrical conductivity no less than 10⁻⁴ S/cm.

13. The polymer composition of claim 12 wherein a bio-degradation rate or bio-compatibility of said polymer is not reduced by said high energy radiation.

14. The polymer composition of claim 12 wherein said electrical conductivity is no less than 10⁻² S/cm.

15. The polymer composition of claim 12 wherein said polymer comprises a naturally occurring polymer selected from the group consisting of collagen, albumin, hyaluronic acid, fibrinogen-fibrin, chitosan, their chemical derivatives, and combinations thereof.

16. The polymer composition of claim 12 wherein said polymer comprises a polymer selected from the group consisting of tyrosine-derived polycarbonates, dioxanone- and dioxepanone-based polymers, polyphosphazenes, poly(anhidrides), poly(ortho esters), poly(amino acids), poly(propylene fumarate), alginate hydrogels, poly(glycolic acid), poly(lactic acid), poly(glycolic-co-lactic acid), poly(dioxanone), poly(caprolactone), poly(ε-hydroxybutyrate), poly(ε-hydroxyvalerate), poly(valerolactone), poly(tartronic acid), poly(β-malonic acid), and combinations thereof.

17. The polymer composition of claim 12 wherein said at least a portion of said polymer comprises a surface of said polymer.

18. The polymer composition of claim 1 wherein said conductivity-rendering species are present in a surface layer of the host polymer.

19. The polymer composition of claim 12 further comprising cells attached to said polymer.

20. The polymer composition of claim 1 further comprising cells attached to said polymer.

21. A bio-electronic device comprising the polymer composition of claim 1.

21. A bio-electronic device comprising the polymer composition of claim 12.
